(19) United States
(12) Patent Application Publication
(10) Pub. No.: US 2012/0196025 A1
(43) Pub. Date: Aug. 2, 2012

(54) Infusion preparation device, related method, and resultant product

(75) Inventors: John William Custer, Washington, DC (US); Nathaniel Bert Jones, Seattle, WA (US); Sauro Dall'Aglio, Seattle, WA (US)

(73) Assignee: COFFEE CATCHER, LLC, Seattle, WA (US)

(21) Appl. No.: 13/015,864

(22) Filed: Jan. 28, 2011

(51) Int. Cl. A47J 31/44; A23F 5/26

(52) U.S. Cl. 426/594; 99/279; 426/431; 426/433; 426/590

(57) ABSTRACT

A device to prepare an infusion, such as a brewed beverage, by moderating and manipulating the extraction rate of a particulate base during an infusion, a related method to prepare such an infusion, and a resultant product of such a method.

### BACKGROUND

Infused liquids comprise an infusion of a particulate base, such as ground coffee beans with a liquid, such as water. The process of creating such an infusion involves extraction, whereby essential qualities of the particulate base are transferred to the liquid.

When infused liquids are prepared as beverages, one of two extraction contact modes is typically employed in an infusion process. Percolation refers to the extraction that occurs during the slow passage of a liquid through a porous surface comprising a particulate base. Immersion refers to the extraction that occurs as a particulate base is soaked in a liquid. In both cases, the infused liquid is generally separated from the particulate base with a filtration apparatus. The resultant liquid becomes the brewed beverage, while the remaining solid particles of particulate base constitute waste. Each extraction contact mode yields an infusion with distinct flavor qualities, and practitioners may utilize a device deploying either percolation or immersion contact mode to create the desired flavor of the resultant beverage.

In addition to utilizing a particular contact mode to optimize desired flavor of the brewed beverage, infusion preparation devices have been developed to exert a degree of control over various extraction parameters that affect the quality of an infusion. Examples of such parameters include liquid temperature, liquid pressure, degree of agitation of immersed particulate base, ratio of particulate base to liquid, size of particulates in a particulate base, and infusion time.

A number of significant extraction parameters, however, remain insufficiently addressed. A particular challenge is the uneven extraction that occurs as a result of the variance in diameter from one particle of particulate base to another, since even the highest quality grinders will yield at least some variance in particle size. Smaller particles have greater surface area relative to density and will extract faster than larger particles, thereby creating a sub-optimal infusion. This challenge affects both percolation and immersion contact modes, and is especially relevant when the particulate base may settle in the infusion preparation container during immersion, as smaller particles may saturate more quickly or hinder filtration. In a percolation mode, these small particles may settle onto the filtration apparatus and disproportionately affect flow rates.

Another insufficiently addressed challenge is the sub-optimal extraction that occurs as a result of an intense extraction event that occurs immediately upon contact between vigorously agitated liquid and particulate base. Such an extraction event may occur at the beginning of an infusion if liquid is added to a particulate base quickly. As a result of such a rapid extraction event, substances in a particle may over-extract, while other substances in that particle that extract slowly may not have time to develop into an infusion.

Related to the two challenges above, infusions may also be optimized by tailoring extraction rates to individual particulate bases. In the case of a prepared beverage, such as coffee, geographic origins and roast profiles of a coffee bean can imbue subtle flavor characteristics to an infusion. Current practice, however, lacks a means to provide discrete controlled extraction of multiple distinct particulate bases in a singular device or infusion process.

To address these and other challenges, it is generally beneficial to have methods and devices that can refine an infusion process, and specifically beneficial to have methods and devices that can manipulate extraction rates of a particulate base during an infusion process.

### SUMMARY

Multiple embodiments of a device and a related method to produce a liquid infusion such as coffee by manipulating the extraction rates of one of more particulate bases during an infusion process. These embodiments comprise a plurality of filtration apparatuses disposed within a infusion preparation container holding a liquid at a suitable temperature and a particulate base such as ground coffee.

The filtration apparatuses may be positioned and moved to moderate or accelerate extraction rates at specific points during the infusion process, resulting in a more even and thorough extraction. The filtration apparatuses may constrain the position and movement of a particulate base to minimize unevenness of extraction due to particle size variability of this particulate base. Similarly, the filtration apparatuses may constrain initial contact of a particulate base with hot liquid to prevent unevenness of extraction.

At a specific point during the infusion process, a filtration apparatus may be moved to commence a total immersion phase and stimulate agitation of the particulate base in the infusion. To complete an infusion process, the remaining solid material of a particulate base may be separated from the infused liquid as well as simultaneously removed from the infusion preparation container.

The multiple embodiments shown also enable discrete control of extraction rates of multiple separate particulate bases as well as extraction of a particulate base via both percolation and immersion contact modes. This flexibility enables the production of an infused beverage comprising a balance of flavor characteristics of each particulate base and contact mode respectively.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is an exploded isometric view of a particular embodiment of a filtration apparatus.

FIGS. 2-5 are side views illustrating a particular embodiment of a brewing device in sequential phases of brewing operations.

FIG. 6 is an exploded isometric view illustrating alternate embodiments of lid and filtration elements.

FIG. 7 is an exploded isometric view of an alternate embodiment of a filtration apparatus.

### DETAILED DESCRIPTION

The following discussion is presented to enable a person skilled in the art to make and use one or more embodiments of the invention. The general principles described herein may be applied to embodiments and applications other than those detailed below without departing from the spirit and scope of the invention. Therefore, the present invention is not intended to be limited to the embodiments described below, but is to be accorded with the widest scope consistent with the principles and features disclosed or suggested herein.

For illustrative purposes, particulate base shall refer to whole coffee beans ground into small particles. The device, however, may be utilized with other particulate flavor bases as well. Likewise, liquid shall refer to water of a temperature suitable for creating an infusion determined by the user of the brewing device. The device, however, may be utilized with liquids other than water.

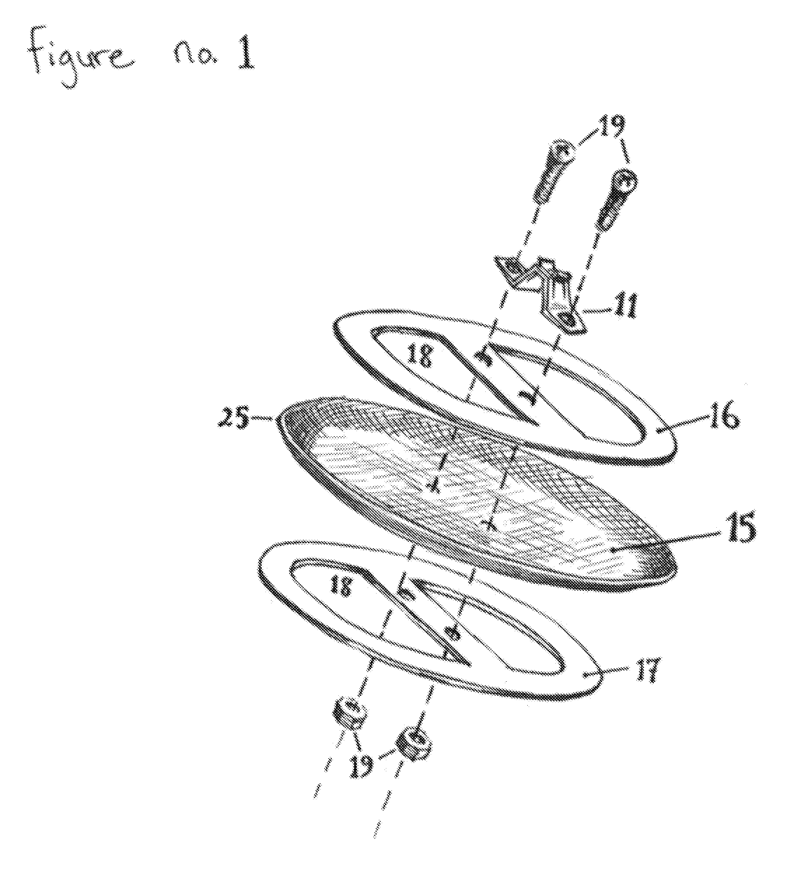

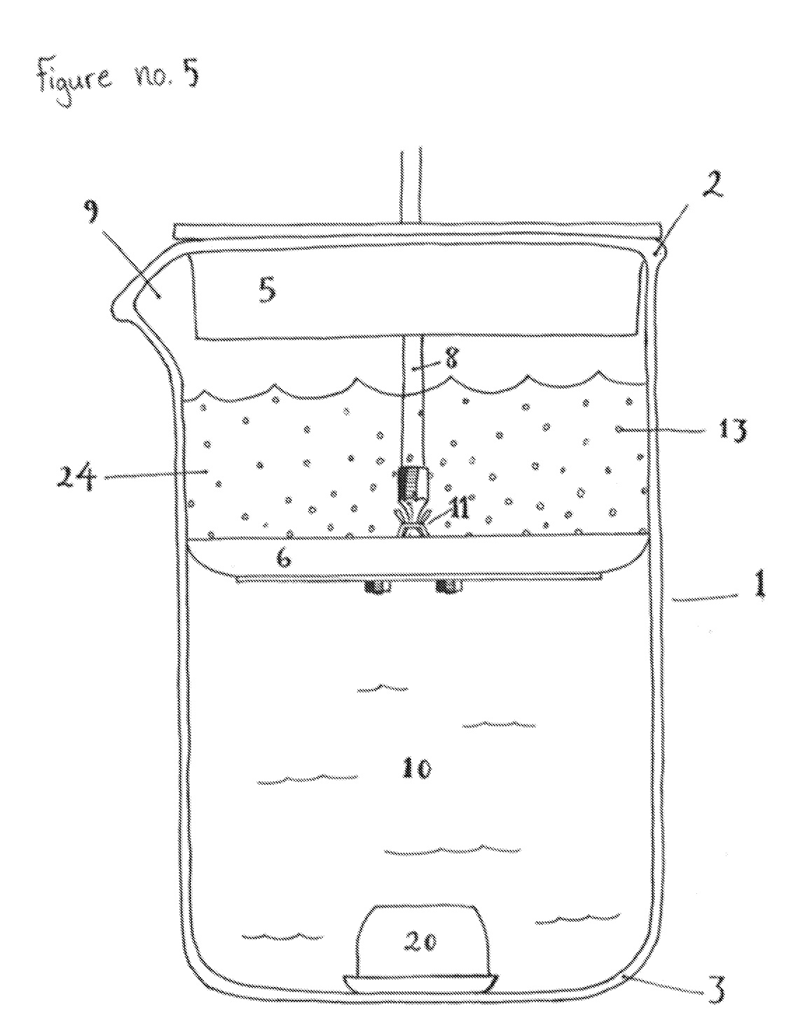

In conjunction with FIGS. 1-7 above, a specific embodiment of the device comprises a cylindrical infusion preparation container (1) that is open at its upper end (2) and closed on its lower end (3), at least one lower filtration apparatus (6), at least one upper filtration apparatus (7), at least one shaft (8) to raise and lower the filtration apparatuses, and a spout (9) for the liquid infusion (10) to exit. The shaft (8) may be connected to a catch mechanism (27), that engages a matching catch (11) located on the upper filtration apparatus (7) or lower filtration apparatus (6), thus enabling the shaft (8) to be attached to or removed from a filtration apparatus (such as 6,7) during brewing operations. The infusion preparation container (1) may be constructed of glass, steel, plastic or another suitable material for containing liquid of a desired temperature. Alternative embodiments (not shown) may not include a spout for the liquid infusion to exit, depending on the requirements of the practitioner.

The brewing device may be utilized to prepare an infusion from one or more particulate bases. In the case of multiple discrete particulate bases, multiple additional filtration apparatuses (such as 12) may be added to provide physical separation between one layer of particulate base (13) and another layer of particulate base (14).

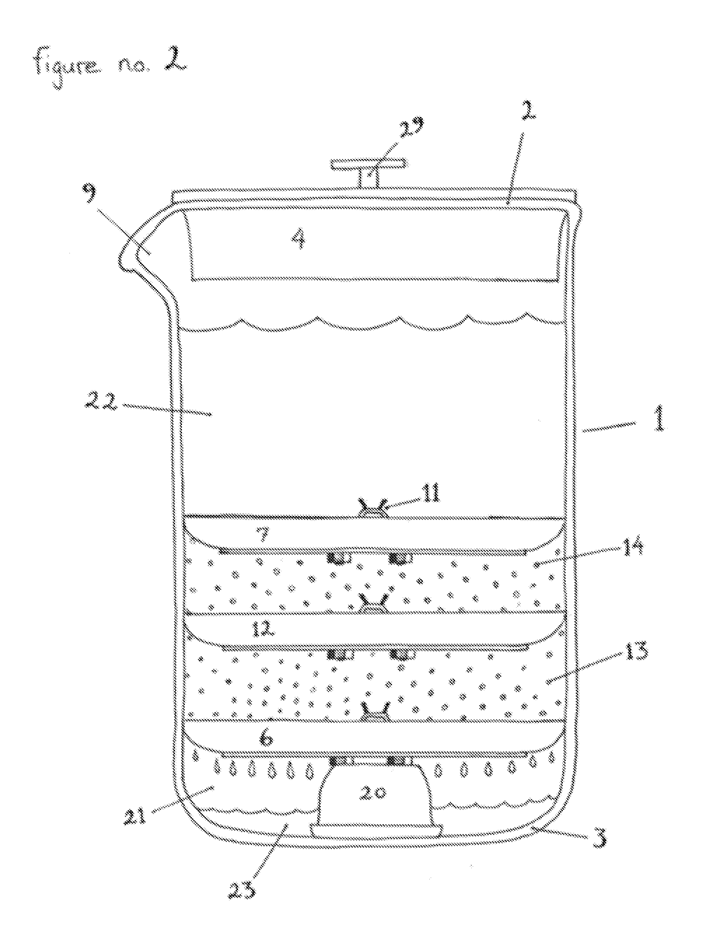

The device may include a lid element (4,5). As illustrated by FIGS. 2-6, the lid shall be of the same general shape as the opening at the upper end (2) of the infusion preparation container (1).

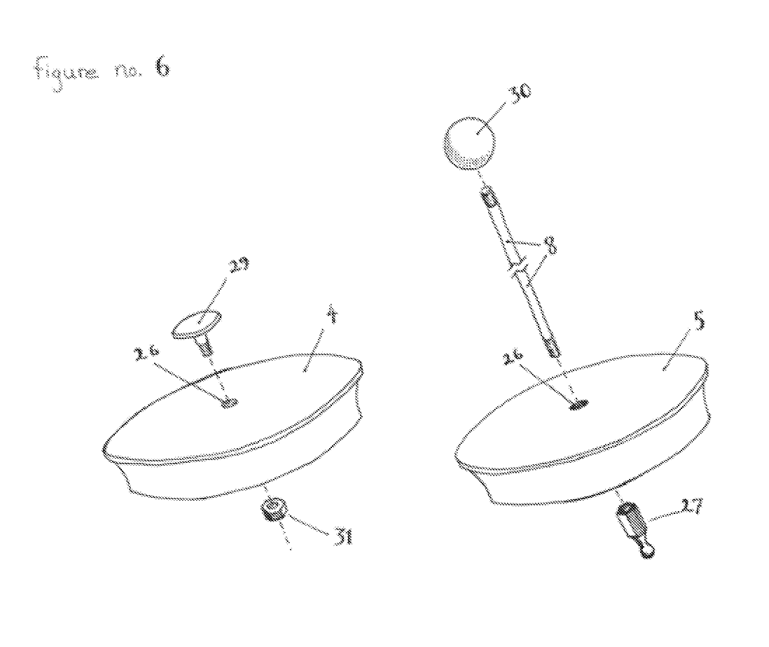

FIG. 6 illustrates multiple embodiments of the lid element (4,5) in the brewing device. One or both of these embodiments of the lid element (4,5) may be utilized in the brewing device as described below.

As illustrated by FIG. 6, in one embodiment, the lid element (4) may comprise a handle (29) that may extend through an opening (26) to attach to a fastener (31). In another embodiment, the lid element (5) comprises a handle (30) fastened to a shaft (8) which extends through an opening (26) to attach to a catch mechanism (27).

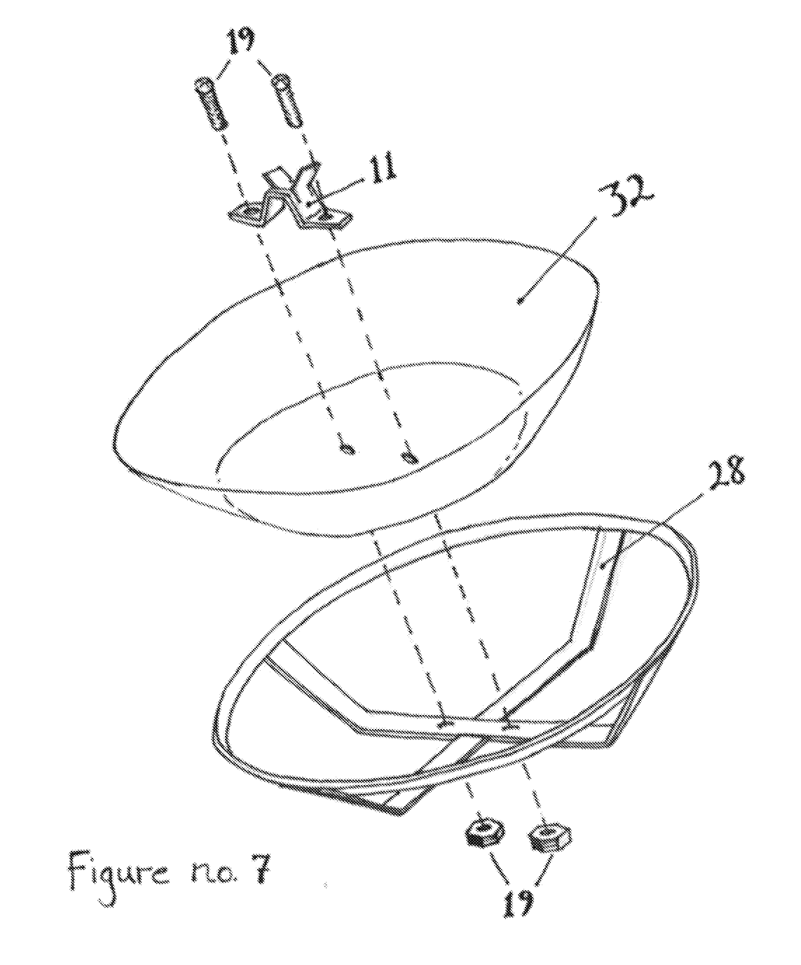

FIGS. 1 and 7, respectively, illustrate multiple embodiments of the filtration element in the brewing device. One or both of these embodiments may be utilized or interchanged in the brewing device as described below. FIGS. 2-6 utilize the particular embodiment of a filtration element illustrated in FIG. 1 to illustrate device operations.

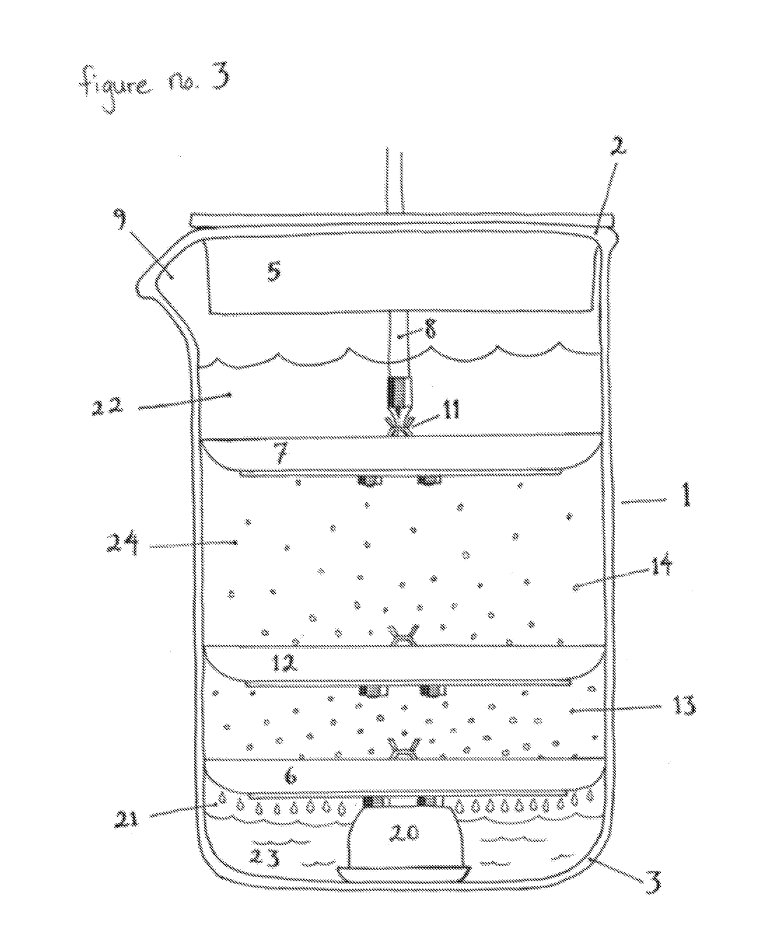

As illustrated in FIG. 1, a filtration apparatus may comprise a middle disc (15) made from steel mesh or other material suitable for performing a filtration function that is held in place by an upper structural support element (16) and a lower structural support element (17). The diameter of the middle filter element (15) may be greater than the diameter of the upper (16) or lower (17) structural support elements to provide optimal contact along the side walls of a cylindrical infusion preparation container (1), a feature illustrated in FIGS. 2-5. Upper, multiple middle, and lower filtration apparatuses (such as 6,7,12) may comprise different gauges of mesh in each respective middle filter element (15). The diameter of the middle filter element (15) shall be approximately equal to the inside diameter of the infusion preparation container (1). The outer edge (25) of the middle filter element (15) is illustrated sloping upward, but the edge of the middle disc (25) may be shaped differently as long as a particular shape provides adequate contact with a particular infusion preparation container. The upper (16) and lower (17) structural support elements may be made from stainless steel or other material suitable for providing structural support, and may include openings (18) that enable portions of the mesh filter element (15) to be visible. Attached to the upper structural support element (16) is a catch mechanism (11) that enables a connection to a matching catch mechanism (27) attached to a shaft (8). This embodiment of such a catch device is illustrated in FIGS. 3-5. The catch device may be fashioned in any way that allows the means by which the filtration apparatus is manipulated to be detached and re-attached to the filtration apparatus itself at the practitioner's discretion. Furthermore, the catch mechanism may be attached to any part of the filtration apparatus or means of manipulating the filtration apparatus as long as a particular arrangement allows the catch to be detached and re-attached at the practitioner's discretion. The catch mechanism (11), upper structural support element (16), middle filter element (15), and lower structural support element (17) may be held together by one or more fastening elements (19). Additional seal-enabling components, such as a gasket made of flexible material (not shown), may be added to a filtration apparatus in alternative embodiments (not shown).

The filtration device itself may be shaped variously according to the specific degree of control over brew parameters desired by the practitioner. As illustrated in FIG. 7, one alternative embodiment of a filter apparatus comprises a frustum shaped element (32) made from steel mesh or other material suitable for performing a filtration function. This mesh (32) is attached to a similarly shaped frame (28) made from stainless steel or another material suitable for performing a structural support function for the base (33) and slanted (34) sides of the frustum. The frustum-shaped structural support element (28) is positioned in such a way that the frustum-shaped filter element (32) is plainly visible. A catch mechanism (11) is shown attached to the upper most frustum. In this particular embodiment, the frustum-shaped filter element (32) is arranged above the frustum-shaped structural support element. In alternative embodiments of filtration apparatuses of various shapes, filters and structural support elements may be arranged in any way that allows the particulate base to be filtered from the brewed beverage. The number of structural support elements may vary, depending on the strength of the filter element, the shape of the container, the consistency of the liquid, the weight of the particulate base and other considerations. In some cases, a filter element may be employed without a structural support element, as long as the filtration function can be performed as desired by the practitioner. The catch mechanism (11), frustum-shaped filter element (32) and frustum-shaped structural support element (28) are held together by at least one fastening element (11). Alternate embodiments of the filtration apparatus of various shapes may include additional seal-enabling elements or additional structural support elements, such as a gasket made of flexible material (not shown), or a shaped wire or spring (not shown) running along the outer circumference of the filter element. In the embodiment shown in FIG. 7, the frustum-shaped mesh filter element (32) may alternatively be fastened below the frustum-shaped structural support element (28) or alternatively sandwiched between two frustum- or disc-shaped structural support elements in the same manner as the three discs in FIG. 1, as long as the filtration process can be controlled in the manner desired by the practitioner.

As illustrated in FIG. 2, the lower filtration apparatus (6) is the first filtration element inserted into the infusion preparation container (1). Prior to inserting the lower filtration apparatus (6), a structural support element (20) may be affixed to or removably placed at the bottom (3) of the infusion preparation container (1). This structural support element (20) provides a support for the lower filtration apparatus (6) to rest on.

This structural support element serves to increase the volume of space in the lower section (23) of the infusion preparation container (1), allowing the practitioner to obtain a greater proportion of percolated infusion in the brewed beverage. The particular size or placement of a structural support element (20) may be varied depending on the particular infusion characteristics desired by the practitioner. In some cases, the practitioner may desire the brewed beverage to consist primarily of an infusion resulting from the immersion contact mode. In these cases, the structural support element (20) below the lower filtration apparatus (6) may be omitted.

As illustrated in the particular embodiment shown in FIG. 2, the user adds a layer of particulate base (13) on top of the lower filtration apparatus (6) and places an additional filtration apparatus (12) on top of the particulate base (13). If an additional particulate base (14) is added, an additional filtration apparatus (7) is placed on top of the additional particulate base (14). As illustrated in the particular embodiment shown in FIGS. 3-5, a catch (27) attached to a shaft (8) may removably attach to a catch mechanism (11) attached to an upper structural support element (16) in order to raise or lower a filtration apparatus (6,7,12) in the infusion preparation container (1). Once the upper filtration apparatus (7) is in place on the top-most layer of particulate base (14), liquid at a desired temperature may be added to the infusion preparation container (1). A lid (4) may be added to the opening at the top end (2) of the infusion preparation container (1) while the hot water “pre-infuses” with the particulate base. During this time, the hot water becomes a “pre-infused liquid” (22). This pre-infused liquid (22) may evidence slight color change whereby the liquid may be tinted but not yet opaque.

Still referring to FIG. 2, during the initial “pre-infusion” phase of brewing described above, the filtration apparatuses (6,7,12) perform a number of functions to moderate the rate of extraction of the particulate base. The layering of filtration apparatuses (6,7,12) above and below a particulate base (13,14) holds said particulate base in place, minimizing the movement of particles in the infusion preparation container (1) and thus minimizing the subsequent sorting of different sized particles of particulate base. Placement of a filtration apparatus (6) below the particulate base (13) creates space in the lower section of (21) the infusion preparation container (1) for percolated liquid (23) to accumulate. With the layer(s) of particulate base(s) (13,14) held in place and space created in the lower section (21) of the infusion preparation container (1), pre-infused liquid (22), may percolate at a moderated rate through layers of particulate bases (13,14) into the lower section (23) of the infusion preparation container (1) to create a component of a brewed beverage with the characteristics of an infusion through percolated extraction. Placement of a filtration apparatus (7) directly above the particulate base (14) prevents an intense but partial infusion event by minimizing immediate contact with the hot liquid (22).

As noted above, various embodiments of filtration apparatuses (6,7,12), including those illustrated in FIG. 1 and FIG. 7 may be interchanged or substituted one for another to refine functionality of the device. For example, if the user desired to increase the flow rate of the percolating liquid, the frustum shaped embodiment of the filtration apparatus illustrated in FIG. 7 may be placed in the position of lower most filtration apparatus (6) in FIGS. 2-5.

As illustrated in FIG. 3, the upper filtration apparatus (7) is raised to mix a particulate base layer (14) with the liquid (23), stimulating a total immersion contact mode and increasing the extraction rate in the infusion process. Subsequent to being raised, the upper filtration apparatus (7) may be removed from the infusion preparation container (1), and the process may be repeated with additional layers of filtration apparatuses (12, 6).

As mentioned above, various embodiments of lids, including the embodiments shown in FIGS. 2, 3, 4, 5, and 6, may be utilized according to the user's preference to operate the device.

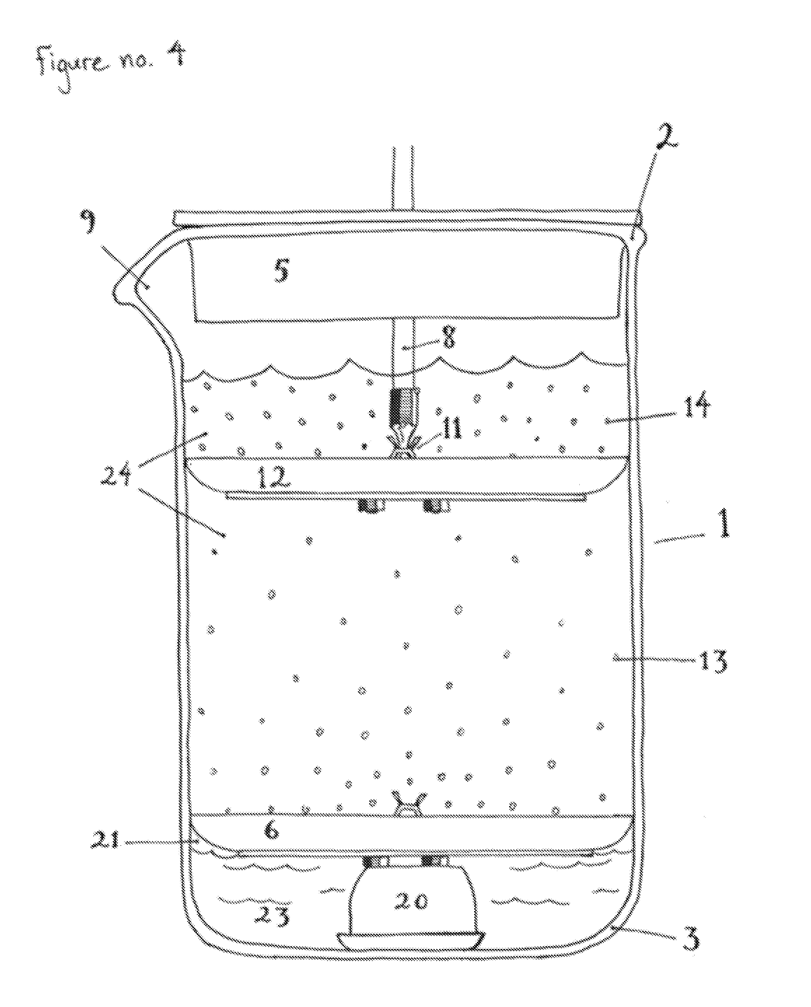

As illustrated in FIG. 4, a middle filtration apparatus (12) is raised. This action filters the particulate base (14) located above said filtration apparatus (12) that has been immersed in the infused liquid (24) and simultaneously mixes the second particulate base (13) into the infused liquid (24). This action of raising the filtration apparatus (12) is followed through until the particulate base (13) above the filtration apparatus (12) has been removed from the infused liquid (24) and, subsequently, the infusion preparation container (1).

As illustrated by FIGS. 3-5, the lower filtration apparatus (6) may be raised to filter the particulate base (13) from the infused liquid (24). The action of raising the lower filtration apparatus (6) simultaneously mixes the liquid (23) below said filtration apparatus (6) that has percolated through the particulate bases (13,14) with the liquid above said filtration apparatus (24) to create a prepared infusion (10) having the characteristics of both an infusion created through percolation and immersion. Upon removal of the particulate base (13) from the infusion preparation container (1), the resultant prepared infusion (10) may be poured from the infusion preparation container (1).

As mentioned above, various embodiments of filtration apparatuses (6,7,12) such as those illustrated in FIG. 1 and FIG. 7 may be interchanged or substituted with one another to refine the functionality of the device. For example, placement of the frustum shaped embodiment of the filtration apparatus described in FIG. 7 in the lower most filtration apparatus position (6) in FIGS. 2-5 may aid the removal of larger volumes of particulate base from the infusion preparation container as the inclined sides (34) of the frustum form a basket shape that contains particulate base when outside the infusion preparation container.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to explain the principles of the invention and its practical application to enable others skilled in the art to utilize the invention in various embodiments and various modifications as are suited to the particular use contemplated. It is intended that the appended claims be construed to include other alternative embodiments except insofar as limited by the prior art.

What is claimed is:

1. A device for preparing an infusion with a liquid and at least one particulate base, the device comprising a container, a lid, a spout, a plurality of filtration apparatuses, and a shaft, wherein said shaft may be removably attached with at least one of said filtration apparatuses

2. The device in claim 1 wherein said particulate base may be removably constrained by said plurality of filtration apparatuses

3. The device in claim 1 wherein contact between said liquid and said particulate base may be removably constrained by said plurality of filtration apparatuses

4. The device in claim 1 wherein at least one of said filtration apparatuses is arranged on a separate but parallel plane with another one of said filtration apparatuses.

5. The device in claim 1 wherein:
said container comprises an open end and a closed end
at least one of said filtration apparatuses may be situated between said open end of said container and a particulate base
at least one of said filtration apparatuses may be situated between said closed end of said container and a particulate base.

6. The device in claim 1 wherein at least one filtration apparatus may be slidably raised or lowered within said container without simultaneously causing a corresponding motion of another filtration apparatus disposed within the container.

7. The device in claim 1 wherein:
Said container is cylindrical and comprises an inside diameter and an outside diameter
Said lid comprises a circular base approximately the same diameter as an opening on said container wherein said lid may removably attach to said container
Said plurality of filtration apparatuses comprise at least one element with approximately the same size as the inside diameter of said container

8. The device in claim 1 wherein:
A material of said container may be comprised of at least one selected from a group of steel, glass, plastic, silicone, ceramic, or wood
A material of said lid may be comprised of at least one selected from a group of steel, glass, plastic, silicone, ceramic, or wood
A material of said filtration apparatuses may be comprised of at least one selected from a group of steel, glass, plastic, silicone, ceramic, or rubber
A material of said shaft may be comprised of at least one selected from a group of steel, plastic, glass, ceramic, or wood

9. The device in claim 1 wherein a prepared infusion is coffee, and a particulate base is ground coffee

10. The device in claim 1, wherein at least one filtration apparatus is frustum-shaped

11. The device in claim 1, wherein at least one filtration apparatus comprises a basket

12. The device in claim 1 further comprising a structural support element below a filtration apparatus

13. The device in claim 1 wherein a filtration apparatus may be situated between a first particulate base and a second particulate base

14. The device in claim 1 wherein a filtration apparatus contains a layer of porous material such as mesh, a layer of structural support such as steel with an opening that renders a layer of the porous material visible, and a fastening element that binds the two layers

15. A method of preparing an infusion, the method comprising:
A pre-infusion phase, wherein contact between a liquid and a particulate base is constrained
An immersion phase, wherein contact between a liquid and a particulate base is unconstrained
A filtration phase, wherein contact between a liquid and a particulate base is eliminated

16. The method in claim 15 wherein a set portion said liquid may percolate through said particulate base during at least one of said phases

17. The method in claim 15 wherein a particulate base is ground coffee and a liquid is water

18. An infusion prepared by the steps of:
Constraining contact between a liquid and a particulate base
Mixing a liquid and a particulate base
Filtering a particulate base from a liquid

19. The infusion in claim 18, further comprising a mixing of a liquid immersed in a particulate base with a liquid that has percolated through said particulate base

20. The infusion in claim 18, wherein said infusion comprises brewed coffee
